(19) United States
(12) Patent Application Publication
(10) Pub. No.: US 2011/0064511 A1
(43) Pub. Date: Mar. 17, 2011

(54) DISPENSING MECHANISM ASSEMBLY

(75) Inventors: Leo Clifford Pires, Basking Ridge, NJ (US); Roger Hwang, Maple (CA); Rahul Bose, New Delhi (IN); Santosh Mohapatra, New Delhi (IN); Koushik Kohli, Uttar Pradesh (IN); Bhavana Vashishtha, Uttar Pradesh (IN)

(73) Assignee: Zen Design Solutions Limited, Wanchai (HK)

(21) Appl. No.: 12/558,076

(22) Filed: Sep. 11, 2009

(51) Int. Cl. B05C 17/00

(52) U.S. Cl. 401/174

(57) ABSTRACT

The present invention generally relates to a dispensing mechanism assembly. In one embodiment, the dispensing mechanism assembly comprises a delivery screw, said delivery screw having at least one sidewall, said sidewall having a plurality of extensions extending along the longitudinal axis of the sidewall, a piston, a piston rod, said piston rod having a profile on its outer periphery to engage with the delivery screw; and an actuating means, said actuating means having a profile on its inner periphery to engage with the plurality of extensions on the delivery screw wherein the delivery screw having a novel structure allows the screw to perform dual function of a conventional screw and of an acoustic generating part. The delivery screw's novel structure reduces the number of parts required in the assembly and thereby lowers the manufacturing costs while providing a soft but firm sound during operation.

### BACKGROUND

1. Field of the Invention

Embodiments of the present invention generally relate to a dispensing mechanism assembly for dispensing product(s). More particularly, the present invention relates to a dispensing mechanism assembly for dispensing product wherein the assembly comprises a novel delivery screw structured such that it has a dual function of a screw and an acoustic generating component and it further helps in overall reduction in manufacturing cost of the dispensing assembly.

2. Description of the Related Art

There are known various dispensing devices for dispensing many types of fluids and various other products such as creams, semisolids, gels, liquids, pastes, and the like. These devices use varying arrangements and configurations of dispensing/propelling mechanisms. The device may employ a push type dispensing or a screw type dispensing mechanism. Generally these dispensing mechanisms include an actuator which is connected to a barrel and both are rotatably connected to each other. In the actuator is provided a threaded rod, a screw and a piston which are so arranged that the rotational movement of threaded rod is restricted with respect to actuator and is axially displaceable with respect to the screw. The actuator when actuated causes the threaded rod to rise up on the screw which in turn causes the piston to push the product upwards in the barrel towards the applicator. Further, there are also present ratchet and spring depending on whether only propelling is desired or propel-repel both are required. A drawback associated with this assembly is that the addition of an independent spring element, in order to bias the ratchet mechanism together, increases the complexity and cost of the dispensing device making it a less than desirable alternative. Further, since the number of parts is large, the manufacturing costs such as molding, assembly or the like are complicated and therefore it is desirable that a low cost be achieved.

Yet, this arrangement of providing propel and propel/repel is required as there are some formulations that need to be kept protected from contamination and some are such which need to be used in less quantities and therefore such modifications/alterations need to be done depending on the usage. On the other hand, provision of these alterations results in having numerous, separate and complex structural elements.

Therefore, while it is important to minimize manufacturing costs and simplify the production process, it is also important that such a dispensing device be convenient and easy for the consumer to use.

Moreover, the dispensers available are unable to provide a smooth, luxurious feel while operating the package as the clicking sound produced is very rough due to the usage of a spring. Moreover, as spring and ratchet collide with every movement, the components are exposed to more wear and tear.

Therefore, there is a need for a device that provides the user with silky, quality feel in the operational handling of the container, while confirming operation to the user.

### SUMMARY

The present invention generally is a dispensing mechanism assembly. More particularly the present invention relates to a dispensing mechanism assembly that is economical in manufacturing. The invention provides for an assembly which is comprised of few components of clearly defined function. This simplifies the handling and simultaneously reduces manufacturing requirements.

There is provided a dispensing mechanism assembly which has a lesser cycle time during manufacturing as compared to the conventional dispensing mechanism assemblies and is therefore cost-effective. The dispensing mechanism assembly of the present invention has reduced assembly time and cost as well as reduced manufacturing costs and time.

The invention also provides for an assembly which when incorporated in a dispensing container for fluids provides an elegant feel to the user while operating it.

According to an embodiment of an invention the dispensing mechanism assembly comprises a delivery screw, a piston, a piston rod and an actuating means wherein the delivery screw is having a novel structure that can help reduce the number of parts required in the assembly and thereby lower the manufacturing costs. The novel delivery screw of the present invention has a structure which allows the screw to perform dual function of a conventional screw and of an acoustic generating part. This novel delivery screw while performing the normal function of a delivery screw generates a soft but firm sound while operation. The piston rod is arranged to be engaged with the delivery screw and the actuating means such that its rotational movement with respect to the actuating means is restricted while its axial movement with respect to the screw is allowed. Further, the delivery screw is structured such that it has a generally cylindrical shape having at least one sidewall wherein the inner periphery of the sidewall has engagement means such as threads to compliment an engagement means present on the outer periphery of the piston rod. The delivery screw further has a plurality of extensions extending along the longitudinal axis of its sidewall, said extensions having a length greater than their width. The said extensions may be in the form of lugs extending along longitudinal axis of the sidewall. The said extensions further may have a profile that operatively engages with a profile on the inner periphery of the actuating means. The profiles on the said extensions may be in the form of cylindrical or triangular protrusions or any suitable profile that provides a harder feedback feel but softer acoustical tone. Further, these profiles on the extensions operatively engage with only a specific area on the inner periphery of the actuating means having a profile thereby generating a sound that is acoustically superior than the conventional ratchet spring mechanism used in the conventional dispensing assemblies. This structure of the delivery screw allows it to generate a soft but firm sound while the actuating means is being actuated. Such a structure of delivery screw comprising of extensions along the longitudinal axis of its sidewall, said extensions being operatively engageable with the profiles on the actuating eliminate the need of a ratchet and spring which are generally used in dispensing assemblies. In conventional dispensing assemblies the entire ratchet part is powered or biased by a spring and is made to smack into the complimentary part to create a clap like hard sound and if the spring is made softer to reduce the impact then the “feedback” feel of the actuator is also dampened. In the dispensing assembly of the present invention the novel delivery screw generates a softer sound with a tactile feel without compromising on the feedback feel. The term “feedback” feel used herein refers to the sound that is generated by the actuation of the actuator to give the user a confirmation of the operation.

According to yet another embodiment of the invention the dispensing mechanism assembly is so arranged that the piston rod is accommodated in the actuating means while the delivery screw is operatively engaged with the piston rod. Further, the plurality of extensions of the novel delivery screw are engaged with the actuating means. On the piston rod is fitted the piston. During operation, as the actuating means is actuated, the piston rod is caused to ride on the screw and thereby cause axial displacement of the piston which pushes the product forward for being dispensed out. While operation, as the actuating means is actuated, the profiles on the extensions of the delivery screw and the actuating means operatively engage with each other and generate an elegant tactile feel as well as sound to the user thereby confirming the operation.

In accordance with yet another embodiment of the invention the actuating means provides the force to actuate the dispensing of the product. However, the force required to operate the actuating means may be applied manually, pneumatically, hydraulically or through various other types of displacement mechanisms.

According to yet another embodiment of the invention there is provided a dispenser comprising the dispensing mechanism assembly described above. The dispenser comprises of an outer body and a cover. The outer body has a proximal end and a rear end and has a cavity to accommodate a fluid product and a dispensing mechanism assembly. The dispensing mechanism assembly comprises a delivery screw, a piston, a piston rod and an actuating means. The outer body may further comprise of an applicator/applicator head. The proximal end of the outer body accommodates the applicator/applicator head. Alternatively, the proximal end of the outer body may integrally have an applicator/applicator head. The rear end of the outer body is engaged to the actuating means. The piston rod is accommodated in the actuating means while the delivery screw is operatively connected to the piston rod. Further, the plurality of extensions of the novel delivery screw are engaged with the actuating means. On the piston rod is fitted the piston. During operation, as the actuating means is actuated, the piston rod is caused to ride on the screw which causes axial displacement of the piston which pushes the product forward towards the applicator head for being dispensed out. While operation, as the actuating means is actuated, the profiles on the plurality of extensions of the delivery screw and the actuating means operatively engage with each other and generate an elegant tactile feel as well as sound to the user thereby confirming the operation. The actuating means provides the force to actuate the dispensing of the product. However, the force required to operate the actuating means may be applied manually, pneumatically, hydraulically or through various other types of displacement mechanisms.

According to yet another embodiment of the invention the profiles on the extensions of the delivery screw operatively engage with the profiles on the inner periphery of the actuating means to enable propel/repel or both propel as well as repel motions with an elegant sound and feel.

According to an alternative embodiment of the invention there may be provided a transparent outer body area that would keep the user informed of the products kept inside the dispenser and thereby making it informative as well as attractive for the user.

Thus, the present invention provides for a simplified, cost-effective, inexpensive, and efficient dispensing mechanism assembly.

The dispensing mechanism assembly of the present invention may be used to dispense a wide variety of consumer and industrial products related to cosmetic, skin care, hair care, oral care, personal care, pharmaceutical, wound care, orally administrable products, home-care or adhesives.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view showing the novel delivery screw of the dispensing mechanism assembly according to an embodiment of the invention;

FIGS. 1a, 1b and 1c are third angle projection views of the delivery screw of FIG. 1 showing the cross-sectional view along the section A-A, the side view and the front view of the delivery screw respectively;

FIG. 2 is an isometric view of the dispenser according to one embodiment of the invention;

FIG. 3 is a cross-sectional view of the dispenser of FIG. 2 in closed condition;

FIG. 4 is an exploded view of the dispenser of FIG. 2;

FIG. 5 is a cross-sectional view of the dispenser of FIG. 2 showing the initial position of the parts of the dispensing mechanism assembly prior to actuation;

FIG. 6 is a cross-sectional view of the dispenser of FIG. 2 showing the displacement of the parts of the dispensing mechanism assembly after full actuation;

FIGS. 7, 7a and 7a′ illustrate the isometric view of the delivery screw, the actuating means and the cross-sectional view of the actuating means respectively of the dispenser of FIG. 2;

FIG. 8 is an isometric view of the dispenser according to one embodiment of the invention;

FIG. 9 is cross-sectional view of the dispenser of FIG. 8 in closed condition;

FIG. 10 is an exploded view of the dispenser of FIG. 8;

FIG. 11 is a cross-sectional view of the dispenser of FIG. 8 showing the initial position of the parts of the dispensing mechanism assembly prior to actuation;

FIG. 12 is a cross-sectional view of the dispenser of FIG. 8 showing the displacement of the parts of the dispensing mechanism assembly after full actuation; and

FIGS. 13, 13a and 13a′ illustrate the isometric view of the delivery screw, the actuating means and the cross-sectional view of the actuating means respectively of the dispenser of FIG. 8.

To facilitate understanding, identical reference numerals have been used, where possible, to designate identical elements that are common to the figures. It is to be noted, however, that the appended drawings illustrate only typical embodiments of this invention and are therefore not to be considered limiting of its scope, for the invention may admit to other equally effective embodiments.

### DETAILED DESCRIPTION

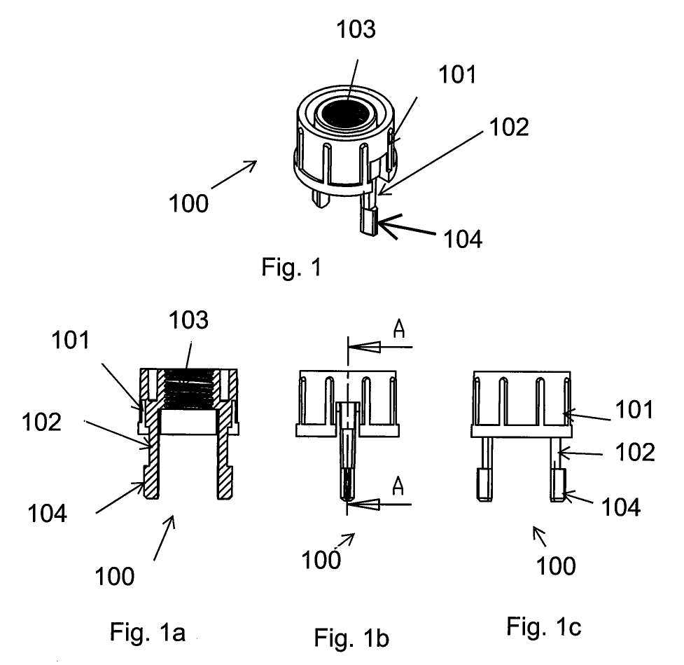

FIG. 1 shows a delivery screw 100 of the dispensing mechanism assembly according to one embodiment of the present invention.

As shown in FIG. 1, the novel delivery screw 100 has a structure which allows it to perform dual function of a conventional screw and of an acoustic generating part. This novel delivery screw 100 while performing the normal function of a delivery screw generates a soft but firm sound while operation. As seen in the FIGS. 1, 1a, 1b and 1c, the delivery screw 100 is structured such that it has a generally cylindrical shape having at least one sidewall 101. The delivery screw 100 has a plurality of extensions 102 extending along the longitudinal axis of its sidewall 101, said extensions 102 having a length greater than their width. The said extensions 102 may be in the form of lugs. The said extensions 102 further have a profile 104 on their lower end. On the inner periphery of the sidewall 101 there are provided engagement means 103 such as threads for engaging with a piston rod. The profile 104 on the said extensions 102 may be in the form of cylindrical or triangular protrusions or any suitable profile that provides a harder feedback feel but softer acoustical tone. Further, these profiles 104 on the extensions 102 operatively engage with only a specific area on the inner periphery of the actuating means having a profile thereby generating a sound that is acoustically superior than the conventional ratchet spring mechanism used in the conventional dispensing assemblies. This structure of the delivery screw allows it to generate a soft but firm sound while the actuating means is being actuated. Such a structure of delivery screw comprising of extensions along the longitudinal axis of its sidewall, said extensions being operatively engageable with the profiles on the actuating eliminate the need of a ratchet and spring which are generally used in dispensing assemblies. In conventional dispensing assemblies the entire ratchet part is powered or biased by a spring and is made to smack into the complimentary part to create a clap like hard sound and if the spring is made softer to reduce the impact then the “feedback” feel of the actuator is also dampened. In the dispensing assembly of the present invention the novel delivery screw generates a softer sound with a tactile feel without compromising on the feedback feel. The term “feedback” feel used herein refers to the sound that is generated by the actuation of the actuating means to give the user a confirmation of the operation.

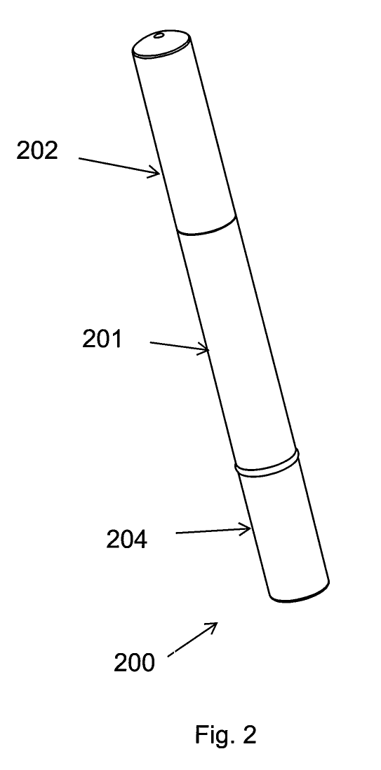

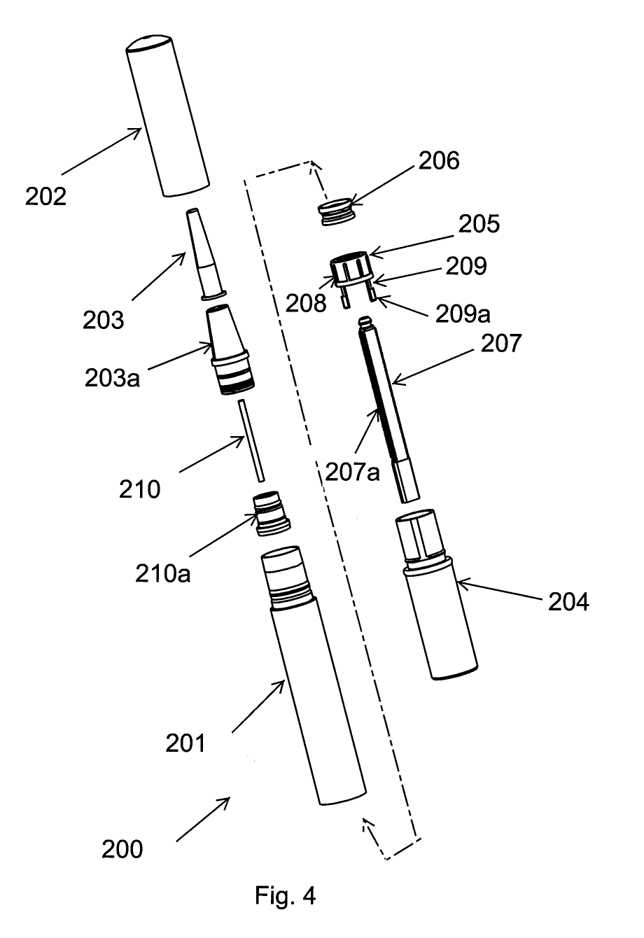

FIGS. 2 through 7 illustrate a dispenser 200 comprising the dispensing mechanism assembly according to one embodiment of the invention. FIGS. 2 through 4 illustrate the dispenser 200 comprising of an outer body 201 and a cover 202. The dispenser 200 further comprises an applicator 203 and an actuating means 204. The outer body 201 has a proximal end and a rear end and has a cavity to accommodate a fluid product and a dispensing mechanism assembly. The dispensing mechanism assembly comprises a delivery screw 205, a piston 206, a piston rod 207 and the actuating means 204. The actuating means 204 provides the force to actuate the movement of the product in the dispenser 200. The proximal end of the outer body 201 accommodates the applicator/applicator head 203. The rear end of the outer body 201 is engaged to the actuating means 204. As shown in FIG. 4 the applicator 203 such as a brush is accommodated in an applicator sleeve 203a via a pipe 210 which in turn is accommodated in a pipe holder 210a. The applicator sleeve 203a engages with the outer body 201.

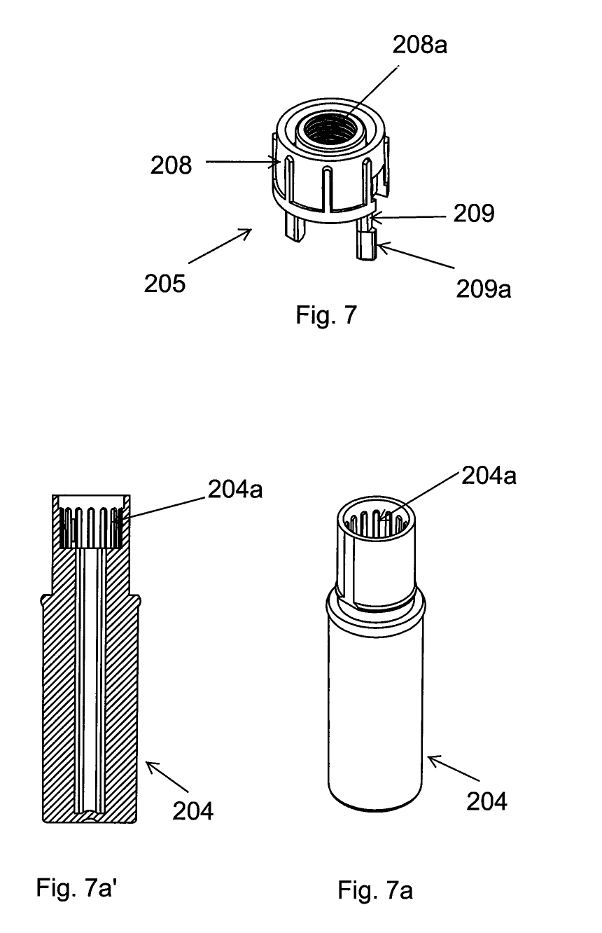

The arrangement of the dispensing mechanism assembly is such that the piston rod 207 is arranged to be engaged with the delivery screw 205 and the actuating means 204 such that the rotational movement of the piston rod 207 with respect to the actuating means 204 is restricted while its axial movement with respect to the delivery screw 205 is allowed. Further, the delivery screw 205 is structured such that it has a generally cylindrical shape having at least one sidewall 208 wherein the inner periphery of the sidewall 208 has engagement means 208a such as threads to compliment an engagement means/profile 207a which is provided on the outer periphery of the piston rod 207. The delivery screw 205 further has a plurality of extensions 209 extending along the longitudinal axis of its sidewall 208, said extensions 209 having a length greater than their width. As illustrated by FIGS. 7 and 7a, the extensions 209 on the delivery screw 205 have a profile 209a on their lower end. The actuating means 204 has profiles 204a on its inner periphery. The profile 209a on the extensions 209 operatively engages with the profile 204a provided on the inner periphery of the actuating means 204. This structure of the delivery screw 205 allows it to function as a conventional screw as well as an acoustic generating part during operation of the assembly. Further, the profiles 209a on the extensions 209 operatively engage with only a specific area i.e. the profiles 204a on the inner periphery of the actuating means 204 thereby generating a sound that is acoustically superior than the conventional ratchet spring mechanism used in the conventional dispensing assemblies. This structure of the delivery screw 205 allows it to generate a soft but firm sound while the actuating means 204 is being actuated.

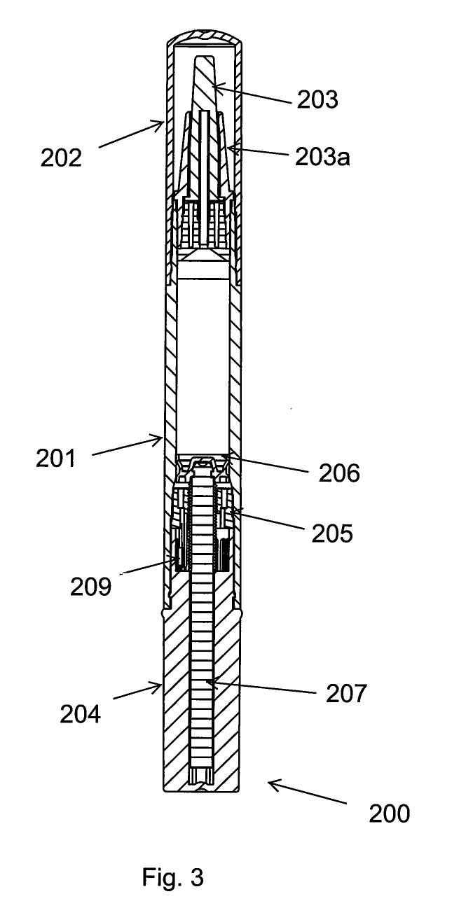

In the dispenser 200 as shown in FIGS. 3 through 7, the piston rod 207 is arranged to sit in the actuating means 204. On the piston rod 207 is fitted the piston 206. The extensions 209 of the novel delivery screw 205 are engaged with the actuating means 204 while the delivery screw 205 is operatively engaged with the piston rod 207.

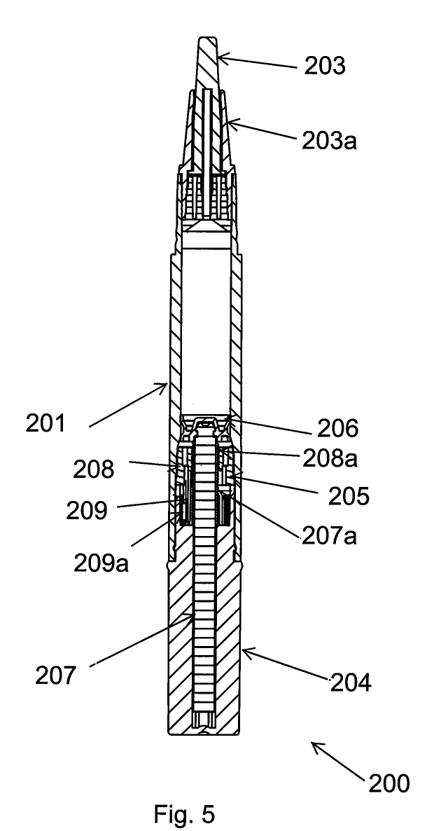

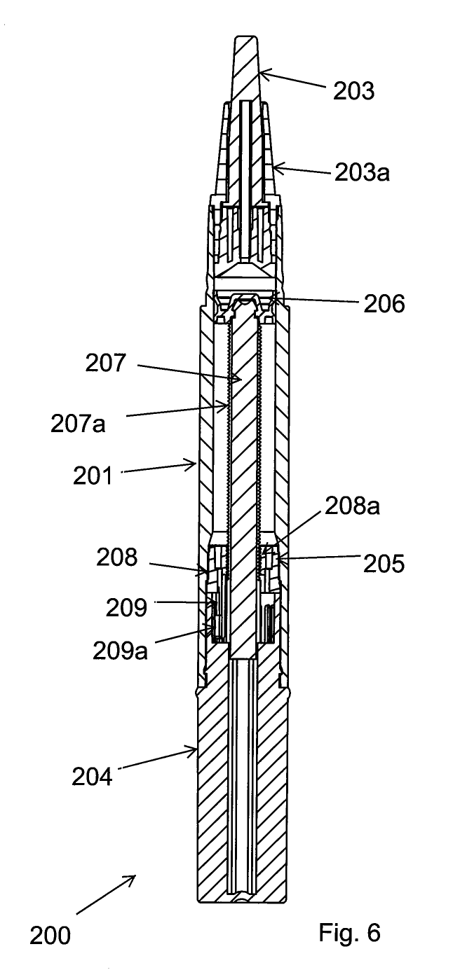

As shown in FIG. 5, the dispenser 200 is an unactuated position. FIG. 6 shows the position of the dispensing assembly parts when full actuation has taken place. During operation, as the actuating means 204 is actuated, the piston rod 207 is caused to ride on the delivery screw 205 and thereby cause axial displacement of the piston 206 which pushes the product forward towards the applicator head 203 for being dispensed out. Further, the profiles 209a on the extensions 209 of the delivery screw 205 operatively engage with profiles on the inner periphery of the actuating means 204 to enable propel/repel or both propel as well as repel motion with an elegant sound and feel. Also, during operation, as the actuating means 204 is actuated, the complimentary profiles on the extensions 209 of the delivery screw 205 and the actuating means 204 respectively operatively engage with each other and generate an elegant tactile feel as well as sound to the user thereby confirming the operation. The actuating means 204 provides the force to actuate the dispensing of the product. However, the force required to operate the actuating means 204 may be applied manually, pneumatically, hydraulically or through various other types of displacement mechanisms.

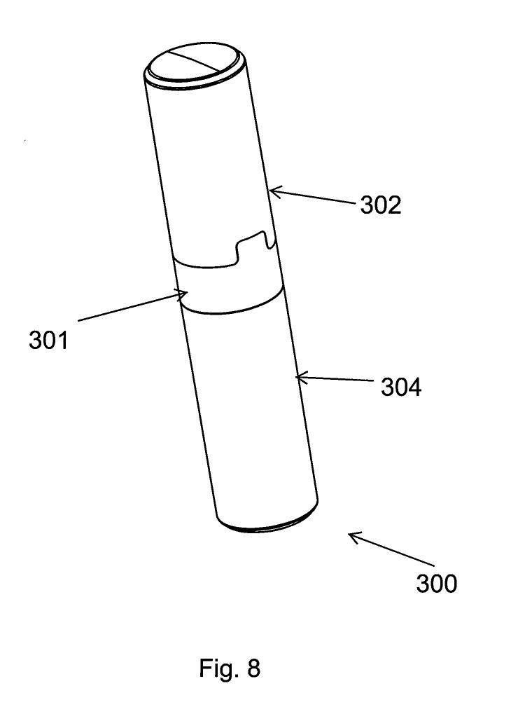

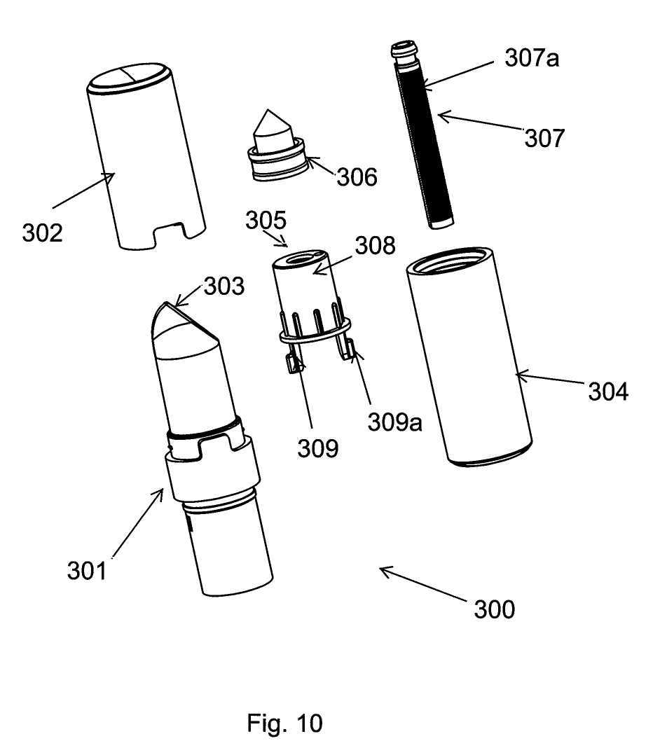

FIGS. 8 through 12 illustrate a dispenser 300 comprising the dispensing mechanism assembly according to another embodiment of the invention. The dispenser 300 comprises of an outer body 301 and a cover 302. The dispenser 300 further comprises an actuating means 304. The outer body 301 has a proximal end and a rear end and has a cavity to accommodate a fluid product and a dispensing mechanism assembly. Further, the proximal end of the outer body 301 is so manufactured to function as an applicator 303. The rear end of the outer body 301 is engaged to the actuating means 304.

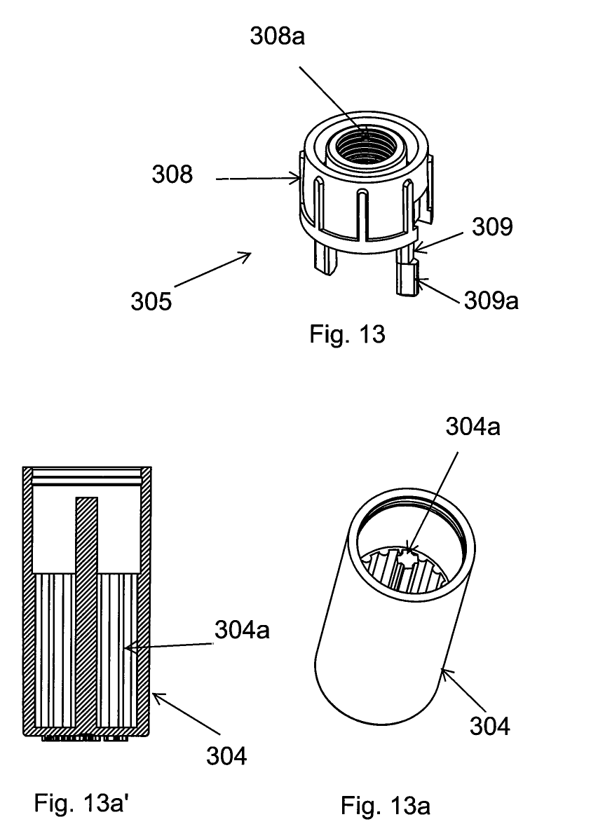

The dispensing mechanism assembly comprises a delivery screw 305, a piston 306, a piston rod 307 and the actuating means 304. The actuating means 304 provides the force to actuate the movement of the product in the dispenser 300. However, the force required to operate the actuating means 304 may be applied manually, pneumatically, hydraulically or through various other types of displacement mechanisms. The arrangement of the dispensing mechanism assembly is such that the piston rod 307 is arranged to be engaged with the delivery screw 305 and the actuating means 304 such that the rotational movement of the piston rod 307 with respect to the actuating means 304 is restricted while its axial movement with respect to the delivery screw 305 is allowed. Further, the delivery screw 305 is structured such that it has a generally cylindrical shape having at least one sidewall 308 wherein the inner periphery of the sidewall 308 has engagement means 308a such as threads to compliment an engagement means/profile 307a which is provided on the outer periphery of the piston rod 307. The delivery screw 305 further has a plurality of extensions 309 extending along the longitudinal axis of its sidewall 308, said extensions 309 having a length greater than their width. As illustrated by FIGS. 13 and 13a, the extensions 309 on the delivery screw 305 have a profile 309a on their lower end. The actuating means 304 has profiles 304a on its inner periphery. The profile 309a on the extensions 309 operatively engages with the profile 304a provided on the inner periphery of the actuating means 304. This structure of the delivery screw 305 allows it to act as an acoustic generating part while operation of the assembly. Further, the profiles 309a on the extensions 309 operatively engage with only a specific area i.e. the profiles 304a on the inner periphery of the actuating means 304 thereby generating a sound that is acoustically superior than the conventional ratchet spring mechanism used in the conventional dispensing assemblies. This structure of the delivery screw 305 allows it to generate a soft but firm sound while the actuating means 304 is being actuated.

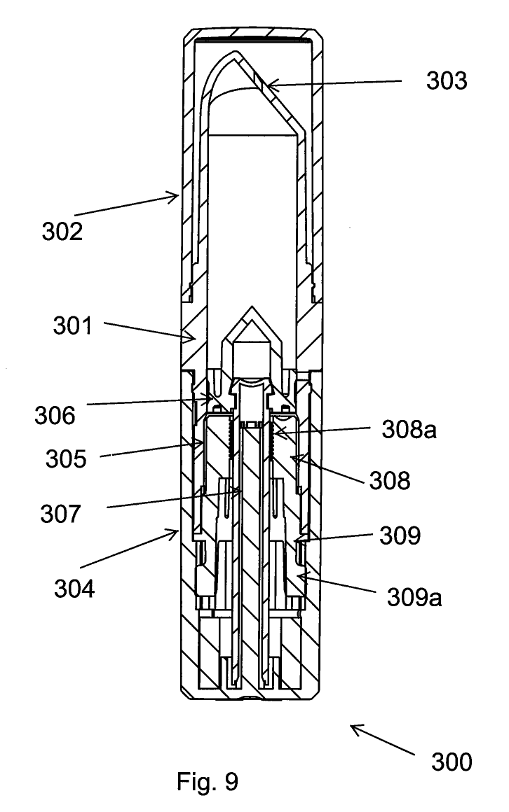

In the dispenser 300 as shown in FIGS. 9 through 13, the piston rod 307 is arranged to sit in the actuating means 304 and on the piston rod 307 is fitted the piston 306. The extensions 309 of the novel delivery screw 305 are engaged with the actuating means 304 while the delivery screw 305 is operatively engaged with the piston rod 307.

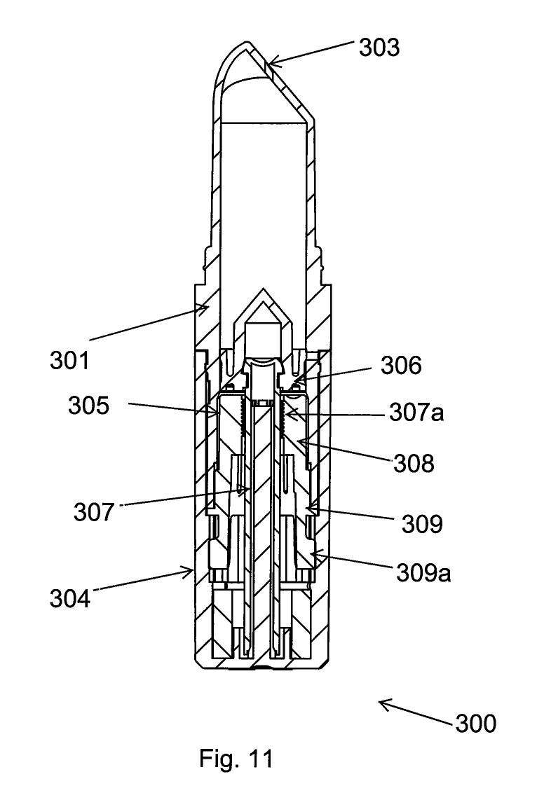

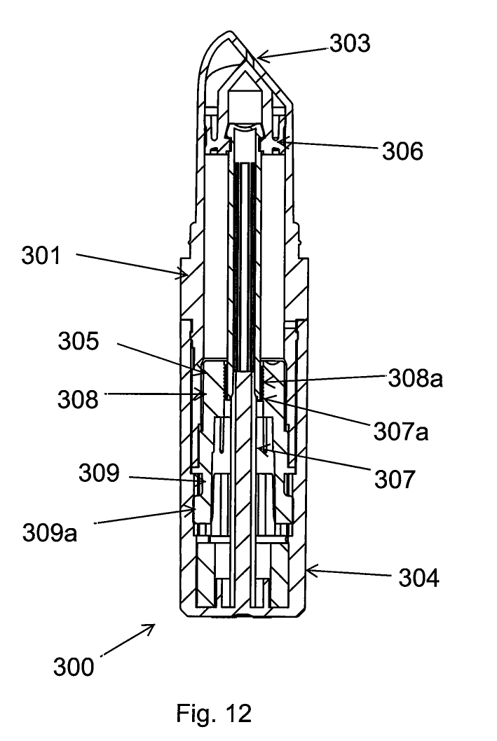

As shown in FIG. 11, the dispenser 300 is in unactuated position. FIG. 12 shows the position of the dispensing assembly parts when full actuation has taken place. During operation, as the actuating means 304 is actuated, the piston rod 307 is caused to ride on the delivery screw 305 and thereby cause axial displacement of the piston 306 which pushes the product forward towards the applicator head 303 for being dispensed out. Further, the profiles 309a on the extensions 309 of the delivery screw 305 operatively engage with profiles on the inner periphery of the actuating means 304 to enable propel/repel or both propel as well as repel motion with an elegant sound and feel. Also, while operation, as the actuating means 304 is actuated, the profiles on the extensions 309 of the delivery screw 305 and the actuating means 304 respectively operatively engage with each other and generate an elegant tactile feel as well as sound to the user thereby confirming the operation.

The outer body of the dispenser according to the invention may be formed of a polymeric material such as PCTA, polypropylene or any other suitable material. The outer body may have any suitable shape such as cylindrical, rectangular or any other suitable shape. The actuating means of the dispenser according to the invention may be formed of a suitable polymeric material such as styrene acrylonitrile or acrylonitrile butadiene styrene or any other suitable material. The materials suitable for forming the piston rod may be polyacetal or any other suitable polymeric/non-polymeric material. The material for forming piston may be any suitable polymeric material such as polypropylene, polyacetal or low-density polyethylene or any other suitable material. The material for forming the delivery screw may be polyacetal or any other suitable polymeric material. The cover of the dispenser may be formed of a suitable polymeric material such as acrylonitrile butadiene styrene or polypropylene or any other suitable material. The aforementioned materials for forming various parts of the dispenser and the dispensing mechanism assembly of the present invention are an example, however other suitable materials may also be used.

Although the above description and drawings show the dispenser being cylindrical, the shapes and profile cross section thereof are not limited to the same. Also, the applicator/applicator head of the dispenser may have any suitable form to target a specific application. The applicator/applicator head may be cylindrical and slightly domed on top having concentric grooves with multiple orifices that contain the product when they are being dispensed. The applicator head may alternatively have any suitable construction which helps in application of the product.

The dispenser of the present invention may be used to dispense a wide variety of consumer and industrial products related to cosmetic, skin care, hair care, oral care, personal care, pharmaceutical, wound care, orally administrable products, home-care or adhesives.

Various examples of the products where the delivery system of the present invention could be used are but not limited to cheek blush, cheek plumping gel/cream, lip plumping gel/cream, moisturizer, sunscreen, temporary hair colors, hair styling gel, hair mousse, hair repair cream, hydrating cream, antiseptic and correction cream, acne treatment cream, concealer, blemish concealer, skin treatment cream, hair repair cream, anti-dandruff cream, hair treatment serum, scalp hydrating oils, teeth whitening gel, teeth whitening and teeth lamination solutions, pain relieving cream, antibiotic cream and analgesic cream, antipyretic and analgesic serums/solutions, bleaching agent, fabric softener, stain remover, bleaching agent, adhesive gels.

While the foregoing is directed to embodiments of the present invention, other and further embodiments of the invention may be devised without departing from the basic scope thereof, and the scope thereof is determined by the claims that follow.

What is claimed is:

1. A dispensing mechanism assembly comprising:
a delivery screw, said delivery screw having at least one sidewall, said sidewall having a plurality of extensions extending along the longitudinal axis of the sidewall,
a piston;
a piston rod, said piston rod having a profile on its outer periphery to engage with the delivery screw; and
an actuating means, said actuating means having a profile on its inner periphery to engage with the plurality of extensions on the delivery screw wherein the delivery screw functions as a conventional screw and as an acoustic generating part.

2. The dispensing mechanism assembly of claim 1 wherein the inner periphery of the sidewall of the delivery screw has engagement means to compliment the profile present on the outer periphery of the piston rod.

3. The dispensing mechanism assembly of claim 2 wherein the plurality of extensions on delivery screw extend along the longitudinal axis of its sidewall, said extensions having a length greater than their width.

4. The dispensing mechanism assembly of claim 3 wherein said extensions further have a profile that operatively engages with the profile on the inner periphery of the actuating means.

5. The dispensing mechanism assembly of claim 4 wherein the piston rod is arranged to be engaged with the delivery screw and the actuating means such that its rotational movement with respect to the actuating means is restricted while axial movement with respect to the screw is allowed.

6. The dispensing mechanism assembly of claim 5 wherein the actuation of the actuating means causes the piston rod to ride on the delivery screw and thereby cause axial displacement of the piston which causes dispensing operation to be completed.

7. The dispensing mechanism assembly of claim 7 wherein the profiles on the extensions of the delivery screw operatively engage with the profiles on the inner periphery of the actuating means to enable the piston rod to move relative to the actuating means.

8. A dispenser comprising:
an outer body, the outer body has a proximal end and a rear end and has a cavity to accommodate a fluid product;
a dispensing mechanism assembly, the dispensing mechanism assembly comprising a delivery screw, said delivery screw having at least one sidewall, said sidewall having a plurality of extensions extending along the longitudinal axis of the sidewall, a piston, a piston rod, said piston rod having a profile on its outer periphery to engage with the delivery screw; and an actuating means, said actuating means having a profile on its inner periphery to engage with the plurality of extensions on the delivery screw, wherein the delivery screw having a structure allows the screw to perform dual function of a conventional screw and of an acoustic generating part; and
a cover.

9. The dispenser according to claim 8 further comprising an applicator/applicator head.

10. The dispenser according to claim 9 wherein the applicator/applicator head is integrally formed on the proximal end of the outer body.

11. The dispenser according to claim 9 wherein the proximal end of the outer body accommodates the applicator/applicator head and the rear end of the outer body is engaged to the actuating means.

12. The dispenser according to claim 11 wherein the actuating means accommodates the piston rod.

13. The dispenser of claim 12 wherein the inner periphery of the sidewall of the delivery screw has engagement means to compliment the profile present on the outer periphery of the piston rod.

14. The dispenser of claim 13 wherein the plurality of extensions on delivery screw extend along the longitudinal axis of its sidewall, said extensions having a length greater than their width.

15. The dispenser of claim 14 wherein said extensions further have a profile that operatively engages with the profile on the inner periphery of the actuating means.

16. The dispenser of claim 15 wherein the piston rod is arranged to be engaged with the delivery screw and the actuating means such that its rotational movement with respect to the actuating means is restricted while axial movement with respect to the screw is allowed.

17. The dispenser of claim 16 wherein the actuation of the actuating means causes the piston rod to ride on the delivery screw and thereby cause axial displacement of the piston which pushes the product forward towards the applicator/applicator head for being dispensed out.

18. The dispenser of claim 17 wherein the profiles on the extensions of the delivery screw operatively engage with the profiles on the inner periphery of the actuating means to enable the piston rod to move relative to the actuating means.

19. A method for dispensing a product from the dispenser as claimed in claim 18 comprising:
actuating the actuating means to dispense the fluid wherein the actuation causes the piston rod to ride on the delivery screw and thereby cause axial displacement of the piston which pushes the product forward towards the applicator/applicator head for being dispensed out wherein the actuation creates an elegant sound and feel during operation.

20. The dispenser as claimed in claim 18 wherein the dispenser is filled with a product related to cosmetic, skin care, hair care, oral care, personal care, pharmaceutical, wound care, orally administrable products, home-care or adhesives.

21. A dispensing mechanism assembly comprising:
a delivery screw, said delivery screw having at least one sidewall, said sidewall having a plurality of extensions extending along the longitudinal axis of the sidewall, said extensions having a length greater than their width;
a piston;
a piston rod, said piston rod having a profile on its outer periphery to engage with the delivery screw; and
an actuating means, said actuating means having a profile on its inner periphery to engage with the plurality of extensions on the delivery screw wherein the delivery screw functions as a conventional screw and as an acoustic generating part wherein the inner periphery of the sidewall of the delivery screw has engagement means to compliment the profile present on the outer periphery of the piston rod and wherein said extensions further have a profile that operatively engages with the profile on the inner periphery of the actuating means and wherein the piston rod is arranged to be engaged with the delivery screw and the actuating means such that its rotational movement with respect to the actuating means is restricted while axial movement with respect to the screw is allowed and wherein the actuation of the actuating means causes the piston rod to ride on the delivery screw and thereby cause axial displacement of the piston which causes dispensing operation to be completed and wherein the profiles on the extensions of the delivery screw operatively engage with the profiles on the inner periphery of the actuating means to enable the piston rod to move relative to the actuating means.

22. A dispenser comprising:
an outer body, the outer body has a proximal end and a rear end and has a cavity to accommodate a fluid product;
a dispensing mechanism assembly, the dispensing mechanism assembly comprising a delivery screw, said delivery screw having at least one sidewall, said sidewall having a plurality of extensions extending along the longitudinal axis of the sidewall, said plurality of extensions of the delivery screw having a length greater than their width; a piston; a piston rod, said piston rod having a profile on its outer periphery to engage with the delivery screw; and an actuating means, said actuating means having a profile on its inner periphery to engage with the plurality of extensions on the delivery screw; and
a cover;
wherein the delivery screw having a novel structure allows the screw to perform dual function of a conventional screw and of an acoustic generating part and wherein the dispenser further comprises an applicator/applicator head; and
wherein the applicator/applicator head is optionally integrally formed on the proximal end of the outer body; and wherein the proximal end of the outer body accommodates the applicator/applicator head and the rear end of the outer body is engaged to the actuating means wherein the actuating means accommodates the piston rod and wherein the inner periphery of the sidewall of the delivery screw has engagement means to compliment the profile present on the outer periphery of the piston rod and wherein said extensions further have a profile that operatively engages with the profile on the inner periphery of the actuating means and wherein the piston rod is arranged to be engaged with the delivery screw and the actuating means such that its rotational movement with respect to the actuating means is restricted while axial movement with respect to the screw is allowed and wherein the actuation of the actuating means causes the piston rod to ride on the delivery screw and thereby cause axial displacement of the piston which pushes the product forward towards the applicator/applicator head for being dispensed out and wherein the profiles on the extensions of the delivery screw operatively engage with the profiles on the inner periphery of the actuating means to enable the piston rod to move relative to the actuating means.
